(19) United States
(12) Patent Application Publication
(10) Pub. No.: US 2005/0050200 A1
(43) Pub. Date: Mar. 3, 2005

(54) Computer system and cluster system program

(75) Inventor: Kenichi Mizoguchi, Fuchu-shi (JP)

Correspondence Address: Finnegan, Henderson, Farabow,;Garrett & Dunner, L.L.P., 1300 I Street, N.W., Washington, DC, 20005-3315, US

(73) Assignee: KABUSHIKI KAISHA TOSHIBA

(21) Appl. No.: 10/927,025

(22) Filed: Aug. 27, 2004

(30) Foreign Application Priority Data
Sep. 2, 2003 (JP) 2003-310161

(51) Int. Cl. G06F 15/173

(52) U.S. Cl. 709/226; 709/220; 709/223

(57) ABSTRACT

In a computer system which achieves a cluster system using two or more computers, a cluster control section has an optimal service allocation section which assigns a service to an optimal computer in accordance with policy information, and a service relocating section which executes relocation of a service according to a change of a load state of the each computer.

### CROSS-REFERENCE TO RELATED APPLICATIONS

This application is based upon and claims the benefit of priority from prior Japanese Patent Application No. 2003-310161, filed Sep. 2, 2003, the entire contents of which are incorporated herein by reference.

### BACKGROUND OF THE INVENTION

1. Field of the Invention

The present invention generally relates to a computer system composed of a plurality of computers, and more particularly, to a technique of a cluster system which achieves an optimal service allocation function according to a failure or load state of a computer.

2. Description of the Related Art

In recent years, there has been developed software technology called a cluster system which manages a computer system composed of a plurality of computers (for example, a server) and which enhances service processing performance and reliability to be provided at a client terminal (user) by executing an application program. The cluster system has a function for scheduling a service which operates on a computer system for an optimal computer during computer startup or in response to an occurrence of a failure or a change of a load state, and achieves improvement of availability or load distribution.

The cluster system is roughly divided into a load distribution type cluster system which emphasizes a load distributing function and a high availability type cluster system which emphasizes a fail-over function (refer to, for example, Rajkumar Buyya, “High Performance Cluster Computing: Architecture and Systems (Volume 1 & 2)”, 1999, Prentice Hall Inc., and KANEKO Tetsuo, MORI Yoshiya, “Cluster Software”, Toshiba Review, Vol. 54, No. 12 (1999), pp. 18 to 21).

The cluster system determines an optimal computer for executing a service based on pre-set policy information which corresponds to a rule on system operation. In general, policy information can be changed by a user setting.

Further, the cluster system uses a reserved computer (provisioning computer) when all the initially set computers are established in a high load state, and there is no optimal computer for allocating a service in the initially set computers.

In recent years, there has been developed a cluster system in which there coexist a load distribution type cluster system and a high availability type cluster system. In such a system, when optimal service allocation (allocation of a service to an optimal computer) is made merely by setting the policy information, there occurs a circumstance in which execution of a service cannot be guaranteed according to a change of a load state of a computer. Specifically, when automatic service switch-over is executed, there has been a circumstance that switch-over occurs frequently with a load change; what action to be taken is not clear when a low priority service is previously executed; or startup is not carried out when there is no computer which is capable of executing a service.

### BRIEF SUMMARY OF THE INVENTION

According to one aspect of the present invention, there is provided a computer system having two or more computers connected to each other, comprising: a policy managing section which changeably stores policy information for determining processing of allocating a plurality of services executed by the computers; an optimal service allocation section which executes processing of allocating each service to an optimal computer according to the policy information; and a service relocation section which executes processing of relocating a service allocated by the optimal service allocation section by referring to the policy information in accordance with a state of executing a service between the computes.

According to another aspect of the present invention, in a complex cluster system in which a plurality of cluster systems including a load distribution type cluster system and a high availability cluster system are provided, a computer system is configured to execute optimal service allocation between cluster systems according to a dynamic change of a load state.

### BRIEF DESCRIPTION OF THE SEVERAL VIEWS OF THE DRAWING

FIG. 1 is a block diagram depicting a system configuration according to a first embodiment of the present invention;

FIG. 2 is a flow chart illustrating procedures for service relocation processing according to the first embodiment;

FIG. 3 is a block diagram depicting a system configuration according to a second embodiment of the present invention;

FIG. 4 is a block diagram depicting a change of the system configuration according to the second embodiment;

FIG. 5 is a block diagram depicting a change of the system configuration according to the second embodiment;

FIG. 6 is a flow chart illustrating procedures for processing of allocating a provisioning computer according to the second embodiment;

FIG. 7 is a flow chart illustrating procedures for processing of disconnecting the provisioning computer according to the second embodiment; and

FIG. 8 is a view showing an example of provisioning policy information according to the second embodiment.

### DETAILED DESCRIPTION OF THE INVENTION

Hereinafter, embodiments of the present invention will be described with reference to the accompanying drawings.

(First Embodiment)

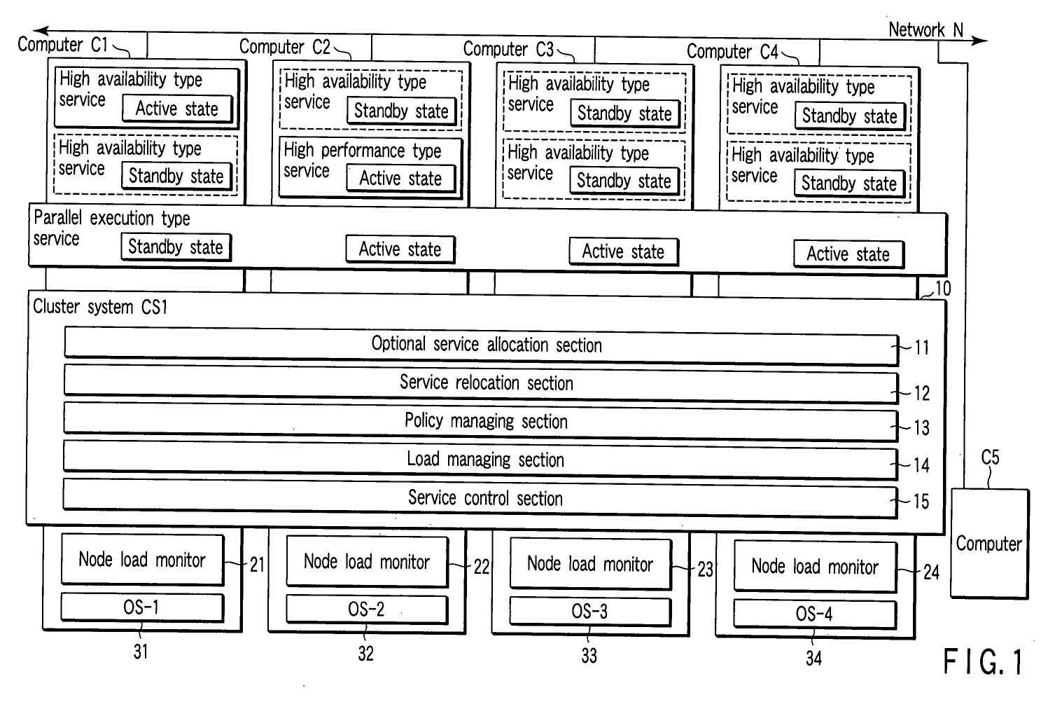

FIG. 1 is a block diagram depicting a system configuration of a computer system according to a first embodiment of the present invention.

In the computer system, for example, four computers C1 to C5 are configured to be mutually connected to one another over a network N. With the computers C1 to C5, computers C1 to C4, for example, are so set that each operates under the control of operating systems (OS-1 to OS-4). Here, the computer C5 is a reserved computer (provisioning computer) which is connected to the computer system via the network N. One or more reserved computers may be connected to the network N in addition to the computer C5.

A cluster system is configured by the computers C1 to C4. In this cluster system, a cluster control section (CS1) 10 operates. The cluster control section 10 is a virtual machine achieved by a cluster control program (cluster software) (not shown) provided in each of the computers C1 to C4 integrally operating in synchronism with another one while making communication with one another. Thus, it is possible to consider that the cluster control section 10 exists across the computers C1 to C4. The cluster control section 10 has: an optimal service allocation section 11 which achieves an optimal service allocation function; a service relocation section 12 which achieves a service relocation function; a policy managing section 13 which achieves a policy managing function; a load managing section 14 which achieves a load managing function; and a service control section 15 which achieves a service control function.

In a case where service startup is required, the optimal service relocation section 11 determines an optimal computer for executing a service in accordance with policy information stored in the policy managing section 13. The policy information specifically specifies policies (operational rules) of the following items (1) to (5), for example.
(1) Service priority

Priority is assigned for executing services every time. Sequences for allocating required resources, i.e., computers are determined in accordance with the service priority. Further, a service with its low priority may be stopped in order to execute a service with its high priority.
(2) Computer priority assigned to service

When a plurality of computers are capable of executing a service, the sequences of preferentially allocated computers are assigned.
(3) Relationship between services (such as exclusive or dependent service)

Services which cannot be executed at the same time are referred as exclusive services each of which lies in an exclusive relationship and a service which can be executed only when another service is executed is referred as a dependent service which lies in a dependent relationship. In addition, a service which cannot be executed by an identical computer is referred as a server exclusive service which lies in a server exclusive relationship and a service which can be executed only when another service is executed by the identical computer is referred as a server dependent service which lies in a server dependent relationship.
(4) Allocating mandatory resources (such as peripheral devices) for executing services

A mandatory resource for executing a service is set, and a service is set so as not to be executed by a computer other than a computer having that resource.
(5) Load state of computer (for allocating to a computer in the lowest load state)

A computer under the lowest load is selected when a service is executed. A condition for, if that service is executed, selecting a computer which is not overloaded, is set.

The service relocation section 12 is an element relating to the gist of the present embodiment. When an imbalance occurs with computer allocation of a service due to a change of a service load state or due to an occurrence of a failure which does not reach computer stoppage, service relocation is determined in accordance with policy information stored in the policy managing section 13.

The policy information concerning this relocation specifies policies of the following items (1) to (4), for example.
(1) Enabling or disabling switch-over of local service

When the switch-over is performed, a service being executed is stopped and then the stopped service is transferred to another computer so as to continue the stopped service. Enabling or disabling this switch-over is set. There are a case of providing static setting and a case of providing dynamic setting for disabling the switch-over when critical processing is executed.
(2) Enabling or disabling stoppage of other services when there does not exist node which can execute service

During startup of one service, when there is no computer which can execute the one service during the startup of this service, enabling or disabling that service to be started up is set by stopping the execution of a service with its lower priority than such one service. In this case, the stopped service may be set so as to ensure switch-over to another computer. These settings can be provided in an entire system, on a service by service basis, or on a computer by computer basis.
(3) Criterion for determining switch-over or stoppage service (high load priority or low load priority)

Examples of criteria include service priorities:
a case in which switch-over or stoppage is preferentially achieved from a service with its highest load;
a case in which switch-over or stoppage is preferentially achieved from a service with its lowest load; and
a case in which switch-over or stoppage is preferentially achieved from a service with its highest priority.

These settings may be set on a system by system basis or on a computer by computer basis.

In addition, it is necessary to set enabling or disabling of switch-over of only one remaining service in consideration of a relationship between the size of the service and a computer capacity. For example, even if a service which becomes overloaded with respect to one computer is switched over to another computer having its capacity which is identical to such one computer, such a service is overloaded. In this case, switch-over is disabled.
(4) Action to be taken when load state changes

When a load state of a computer changes, it is set whether or not to execute service switch-over or stoppage and the like. A load state can be set by a variable threshold value of the load variation or the like.
(4-1) In the case where maintaining a current state is emphasized, service relocation is executed to an extent such that no service switch-over or stoppage occurs.
(4-2) In the case where optimal allocation is emphasized, even if service switch-over or stoppage occurs, a service is relocated so as to be optimal.

For example, after a failure has occurred to an extent such that one computer does not reach its stoppage, when a capacity of such one computer is lowered, a service relocating section described later senses its necessary. Then, service relocation processing is carried out.

These items of policy information can be set in advance by a user. A service determined to be relocated is established in a stopped state until a computer to execute this service is allocated by means of the optimal service allocation section 11.

The policy managing section 13 stores and manages policy information used by the optimal service allocation section 11 or the service relocating section 12.

The load managing section 14 determines a service load or a computer load state at each of the computers C1 to C4. When service relocation is required based on this determination result, the fact is notified to the service relocating section 12 together with load information. Having received this notification, the service relocating section 12 executes service relocation processing as described later.

The load information includes a used quantity or a response time of a CPU, a memory, or a disk of each of the computers C1 to C4. In addition, the computers C1 to C4 have node load monitors 21 to 24, and monitor a respective load state.

(Operation of Cluster Control Section)

The cluster control section 10 manages execution of a parallel execution type service and a high availability type service created by a user. The parallel execution type service is, for example, a Web service or the like, and is a service of such type which can be executed by a plurality of computers C1 to C4 at the same time. The number of services when the parallel execution type services are executed at one time is managed by the load managing section 14.

The number of services increases as a higher load is applied, and the number of services decreases as a lower load is applied.

On the other hand, the high availability type service created by a user is, for example, a database search service, and is a service of such type which can be executed only by any one computer (for example, C2) at one time. The high availability type service is produced so as to continue processing after moving to another computer due to a fail-over at an occurrence of a failure or due to switch-over at the time of failure prediction or at the time of a high load.

For example, when a load of a high availability type service being executed by the computer C2 rises suddenly, if the load managing section 14 of the cluster control section 10 determines that a load on the computer C2 is close to its upper limit, the necessity of service relocation is notified to the service relocating section 12.

The service relocating section 12 starts service relocation processing of a high availability type service or a parallel execution type service in accordance with policy stored in the policy managing section 13 (which can be set by the user).

Specifically, when the service relocating section 12 determines, for example, relocation of a parallel execution type service, the service control section 15 having received this determination temporarily stops the parallel execution type service. After stopping this parallel execution type service, the optimal service allocation section 11 selects an optimal computer (for example, C1) for executing the service. The service control section 15 on the selected computer (for example, C1) executes automatic service switch-over by starting up the parallel execution type service.

Optimal service allocation corresponding to a dynamic load change can be carried out by a service automatic switch-over mechanism using the cluster control section 10 as described above.

(Service Allocation Processing)

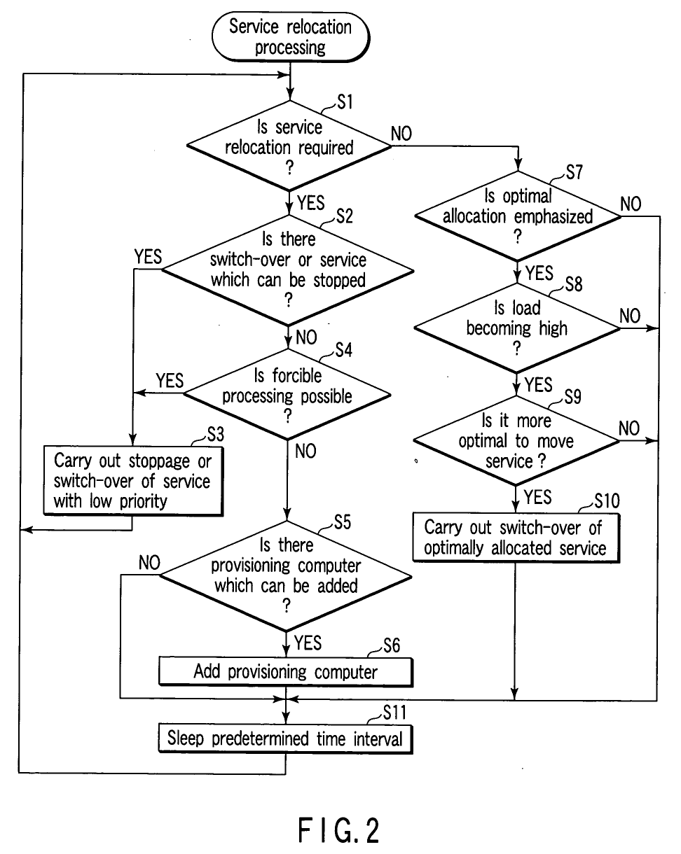

Hereinafter, procedures for service allocation processing of the cluster control section 10 according to the present embodiment will be described with reference to the flow chart of FIG. 2.

The service relocating section 12 executes inquiry to the policy managing section 13, and executes relocation processing in accordance with setting of policy information set by a user, for example. Policy information specifies policies of the following items (1) to (4), for example, as described previously.
(1) Enabling or disabling switch-over on a service by service basis
(2) Enabling or disabling stoppage of another service when there is not node capable of executing a service
(3) Criteria on switch-over or stoppage of a service:
   (3-1) High load priority or low load priority,
   (3-2) Enabling or disabling switch-over of last service.
(4) Action to be taken when a load state changes:
   (4-1) Relocation to an extent such that service stoppage does not occur in the case where maintaining a current state is emphasized,
   (4-2) Relocation while service stoppage occurs in the case where optimal allocation is emphasized.

As described previously, the load managing section 14 determines whether or not service relocation is required according to determination of a load state (step S1). The criteria include, for example, “a case in which a computer is continuously under a high load and a delay of service execution is predicted”, “a case in which there exists a high priority service under a high load (prediction) waiting for a computer to execute”, and the like. It is determined that service relocation is required.

Now, processing when service relocation is required (YES at step S1) will be described here.

The service relocating section 12 determines whether or not there exists service switch-over or a service which can be stopped, in accordance with policies (1) and (3) of above-mentioned policy information (step S2). When the determination result is YES, the service control section 15 of the cluster control section 10 executes service switch-over until there has been no need for service relocation from the lowest priority than a service in which switch-over can be set to be enabled (step S3).

On the other hand, when there does not exist a service in which switch-over is enabled, the service relocating section 12 determines whether or not forcible processing can be carried out in accordance with policy (2) of policy information (NO at step S2 and step S4). If forcible processing is enabled, the step goes to processing for executing switch-over until there has been no need for service relocation from the lowest priority (YES at step S4 and step S3).

If forcible processing is disabled, the cluster control section 10 makes a search for an available provisioning computer (reserved computer). In the case where there exists a reserved computer C5, the computer C5 is added (NO at step S4, steps S5 and S6). The thus added provisioning computer C5 is returned when a load on the computer system is lowered in the case where it is specified to be returned and when the load on a computer system is lowered. In the case where an available provisioning computer does not exist, “return” is established through a sleep state of a predetermined time interval (NO at step S5 and S11).

Now, a description will be given with respect to a case in which service relocation is not required based on the determination result of the load managing section 14 (NO at step S1).

In the case where a high load is being established when optimized allocation is emphasized (YES at step S7 and YES at step S8) in accordance with policy (4-2) of policy information, the service relocating section 12 executes service relocation processing. Otherwise (NO at step S7 and NO at step S8), service relocation processing terminates.

Here, in determination of whether or not a computer is being under a high load, a load averaged at a predetermined interval increases monotonously. It is possible to determine whether or not a high load can be predicted in the near future.

Further, in the case of executing service relocation processing, the service relocating section 12 determines whether or not more optimal allocation can be achieved by moving a service. When the determination result is optimal, this service relocation section 12 executes service switch-over (YES at step 9 and step S10). When optimal allocation cannot be determined, service relocation processing terminates (NO at step S9).

Here, the criteria for optimal allocation include: when in a case in which a service relocated by the selected computer has been operated under a load which is identical to a current load, a state of load among the computers can be more averaged. In addition, the above criteria include a case in which, even considering an overhead of service switch-over, it is considered earlier to carry out processing by the selected computer.

Here, as a policy of service relocation, enabling or disabling of switch-over on a service by service basis or a policy in which maintaining a current state is emphasized can be carried out. Even if stoppage occurs due to switch-over, the stopped service will not be executed when startup cannot be carried out by a computer which is a switch-over destination, thereby making it possible to prevent switch-over operations from being repeated in sensitive response with a load change of a computer.

As described above, in summary, the cluster system of the present embodiment provides a service relocating function managed by a policy by policy basis, thereby making it possible to relocate a service according to a dynamic change of a load state and making it possible to easily achieve construction of a cluster system suitable to an environment for a user operation.

(Second Embodiment)

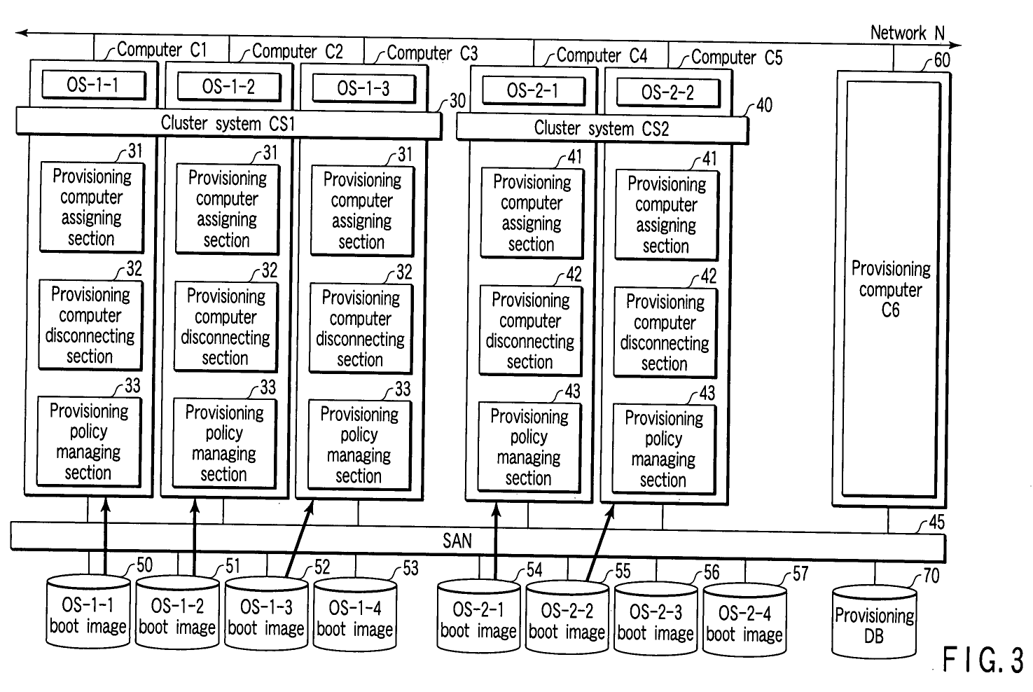

FIGS. 3 to 5 are block diagrams depicting a system configuration of a computer system according to a second embodiment of the present invention and changes of the system configuration shown in FIG. 3.

As shown in FIG. 3, a computer system in an initial state is configured so that, for example, five computers C1 to C5 are interconnected with one another over a network N. Further, a sixth computer C6 is connected over the network N. The computer C6 is set in a stopped state at first, and is registered in a provisioning computer pool 60 as a provisioning computer (reserved computer).

The provisioning computer pool 60 is conceptually illustrated so that one or more initially stopped computers are registered as provisioning computers, and is defined as a generic name.

Registering a provisioning computer in the provisioning computer pool 60 denotes registering information (such as a processor name or a MAC address, for example) concerning provisioning computers (not shown) as registration information. This registration information manages a plurality of provisioning computers registered in the provisioning computer pool 60.

The computers C1 to C3 are operating under the operating systems OS (OS-1-1 to OS-1-3), respectively. In addition, the computers C4 and C5 are operating under the control of operating systems OS (OS-2-1, OS-2-2), respectively.

In the computers C1 to C5 under operation, there operates: a provisioning computer assigning section 31 which achieves a provisioning computer assigning function; a provisioning computer disconnecting section 32 which achieves a provisioning computer disconnecting function; and a provisioning policy managing section (hereinafter, simply referred to as a “policy managing section”) 33 which achieves a provisioning policy managing function. In the computer C1, the computer C2, and the computer C3, respectively, there operate the provisioning computer assigning section 31, the provisioning computer disconnecting section 32, and the provisioning policy managing section 33. Then, these sections are linked in synchronism with each other while making communication with each other, whereby the computer C1, the computer C2, and the computer C3 configure a cluster system CS1. The reference numeral 30 schematically illustrates the cluster control section in the cluster system CS1. On the other hand, in the computer C4 and the computer C5, respectively, there operate the provisioning computer assigning section 31, the provisioning computer disconnecting section 32, and the provision policy managing section 33. These sections are linked in synchronism with one another while making communication with one another, whereby the computer C4 and the computer C5 configure a cluster system CS2. Reference numeral 40 schematically illustrates the cluster control section in the cluster system CS2. These cluster control sections 30, 40 are independent of each other, and there is no case in which services are associated with each other.

In this computer system, a plurality of storage devices (disk devices) 50 to 57 and 70 are connected to each other via a storage area network SAN which is denoted by a reference numeral 45.

In this computer system, boot images for starting up the computers each are stored in advance and registered in the storage devices or disk devices 50 to 57. The boot images used here include an operating system for starting up a computer and an application program which can be executed by this operating system.

The storage devices 50 to 53 and 54 to 57 each register boot images OS-1-1, OS-1-2, OS-1-3, OS-1-4, OS-2-1, OS-2-2, OS-2-3, and OS-2-4. For example, the boot image (OS-1-3) for starting up the computer C3 is registered in the storage device 52 as shown by an arrow in the figure. When the computer C3 is started up by using this boot image (OS-1-3), the computer C3 serves as an operating computer whose operation is controlled by the OS (OS-1-3). In FIG. 3, there is shown which of the computers is started up by which of the boot images, as indicated by the arrows.

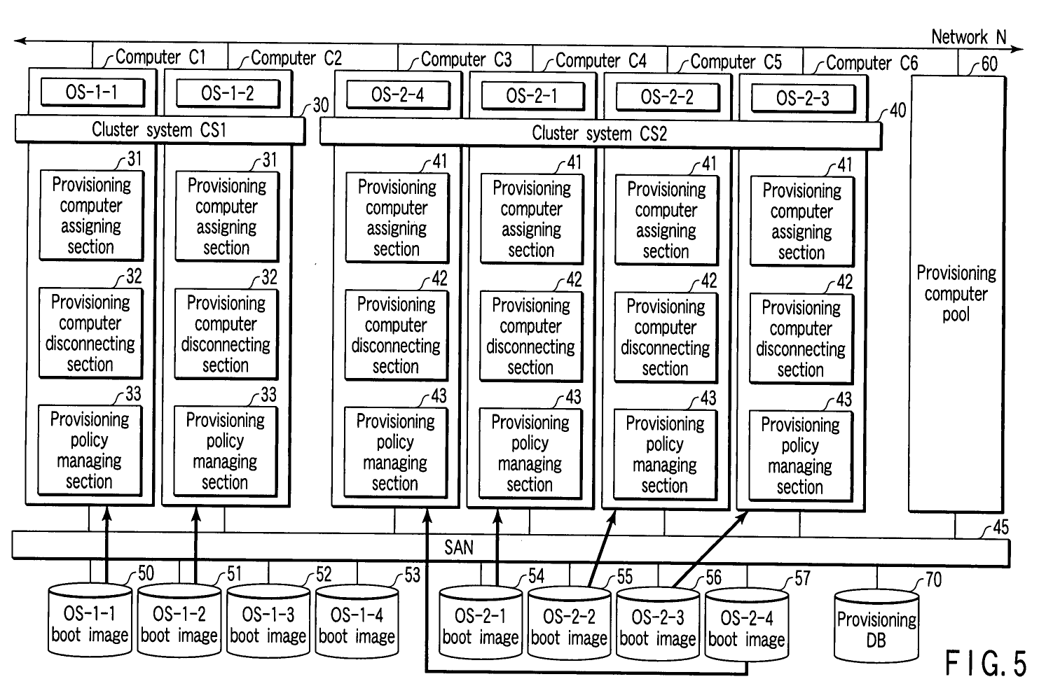

On the other hand, as shown in FIG. 5, the boot image (OS-2-4) for starting up the computer C3 is registered in the storage device 57. When the computer C3 is started up by using this boot image (OS-2-4), the computer C3 serves as an operating computer whose operation is controlled by the OS (OS-2-4). In FIG. 5, there is shown which of the computers is started up by which of the boot images, as indicated by the arrows.

(Operation of Cluster System)

When a computer to be executed by the cluster control sections 30, 40 is required, the provisioning computer assigning section 31 assigns a provisioning computer to a cluster system in accordance with provisioning policy information stored in a provisioning policy database (hereinafter, referred to as a policy DB) which can be accessed via the policy managing section 33.

When a redundancy occurs with a computer being executed by the cluster control sections 30, 40, the provisioning computer disconnecting section 32 disconnects the computer in the cluster system, and registers the disconnected computer as a provisioning computer in the pool 60 in accordance with the policy DB 70 which can be accessed via the policy managing section 33.

The policy managing section 33 provides a setting or referencing function for provisioning policy information (hereinafter, simply referred to as policy information). The policy information specifies provisioning policies of the following items (1) to (4), for example.
(1) Computer assigning level on a cluster system basis (priority)

When a provisioning computer request has been made from two or more cluster systems at the same time, the sequence (priority) of preferentially assigned cluster systems is set. When no requested provisioning node is prepared, there is a case in which a computer assigned to a cluster system with its low priority is assigned forcibly to a requested cluster system.
(2) Enabling or disabling return of provided computer

It is set whether or not a provisioning computer assigned in a cluster system can be returned to the provisioning pool 60. Therefore, in the case where the return is disabled by this setting, the number of computers assigned in that cluster system will be increased.
(3) Enabling or disabling forcible return of provided computer

It is set whether or not a computer provided from a provisioning pool to a cluster system can be forcibly returned. That is, even if the computer is forcibly returned, a condition for providing setting of whether or not system operation fails is established. For example, when a request is made from a cluster system with its high priority, in the case where a reserved computer does not exist in the provisioning pool 60, setting is provided so that a forcible return request is provided to a cluster system with its low priority.
(4) Indication of the number of computers to be provided in the system (number of mandatory computers, maximum number of computers, and number of initial computers)

The number of computers required for configuring a cluster system is defined as the number of mandatory computers. A maximum number of computers which can be assigned to a cluster system is defined as a maximum number of computers. In addition, the number of optimally assigned computers during startup of a cluster system is defined as an initial number of computers. Thus, an indicator for determining the number of computers provided to the cluster system can be set.

Policy information, in general, is set to the policy DB 70 during the user construction or maintenance of a computer system.

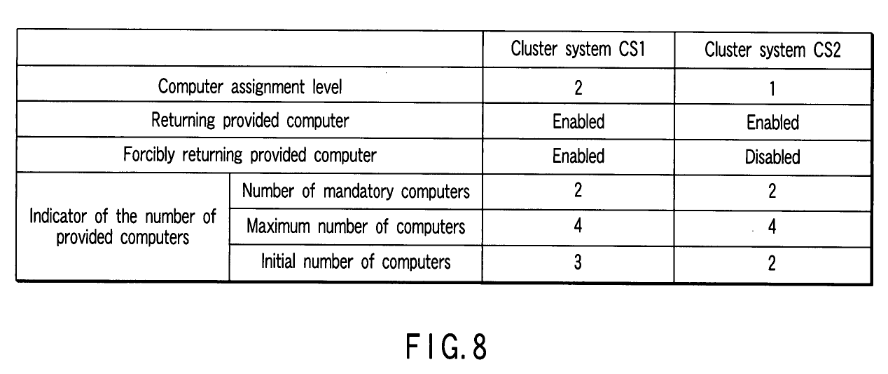

FIG. 8 shows an example of provisioning policy information registered in the provisioning DB 70 to be registered in each computer in the cluster system shown in FIG. 3.

(Provisioning Computer Assigning Processing)

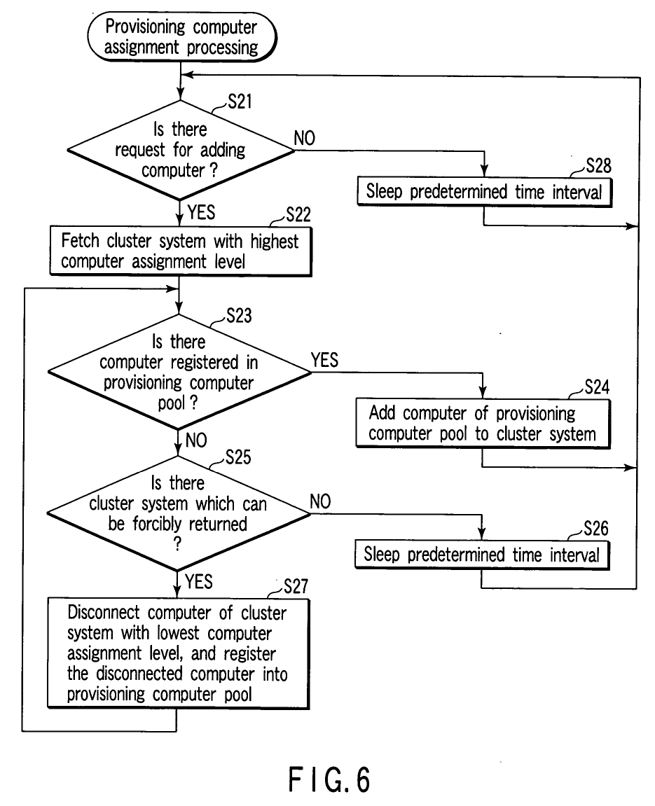

Hereinafter, procedures for provisioning computer assignment processing according to the present embodiment will be described with reference to the flow chart of FIG. 6.

First, as shown in FIG. 3, in a computer system in an initial state, the computers C1 to C3 are operating, and the cluster control section 30 in the cluster system CS1 is operating. In addition, the computers C4, C5 are operating, and the cluster control section 40 in the cluster system CS2 is operating. Further, the computer C6 stops, and is registered in the pool 60 as a provisioning computer.

Here, after a load on the cluster system CS2 has increased, when a state in which processing cannot be carried out by the two computers C4, C5 is established, the cluster system CS2 requests the provisioning computer assigning section 41 to add a computer (YES at step S21).

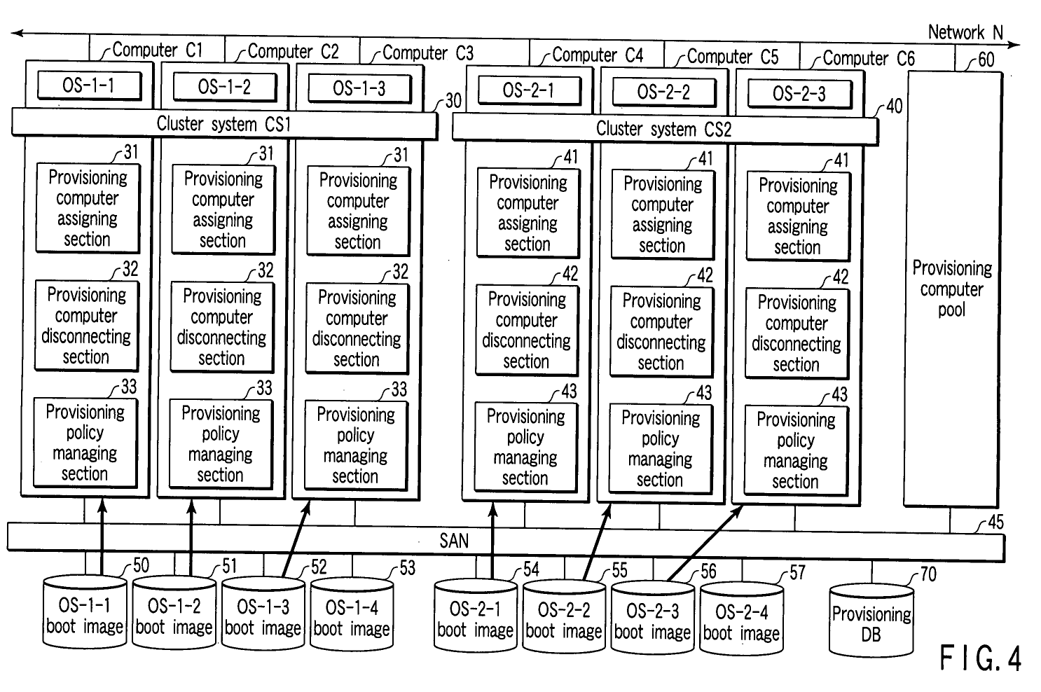

The provisioning computer assigning section 41 makes a search for the provisioning computer pool 60; retrieve the registered computer C6; and adds the retrieved computer C6 to the requested cluster system CS2 (YES at step S23 and step S24). Here, the provisioning computer assigning section 41, as shown in FIG. 4, fetches from the storage device 56 the boot image (OS-2-3) which is not used from among the boot images belonging to the cluster system CS2. This assigned boot image (OS-2-3) is started up when it is connected to the computer C6.

However, in the case where a requirement to be met by the boot image has been specified in detail from the cluster system CS2, a search is made for a boot image conforming to that requirement.

In the meantime, in the case where a request for adding a computer has been made from the two cluster systems or cluster control sections 30, 40 at the same time, the provisioning computer assigning sections 31, 41 access the policy DB 70 via the policy managing sections 33, 43, and selects one of the cluster control sections 30, 40 with its high computer assignment level in accordance with policy information (step S22). For example, the cluster system CS2 of the cluster control section 40 has a higher assignment level, the provisioning computer assigning section 41 makes a search for the provisioning computer pool 60, and preferentially assigns the registered computer C6 (YES at step S23 and S24).

Further, after a load on the cluster system (CS2) has increased more, when processing cannot be carried out by the three computers C4 to C6, the cluster control section 40 requests the provisioning computer assigning section 41 to add an additional computer.

The provisioning computer assigning section 41 determines whether or not a provisioning computer which can be forcibly returned exists in the other cluster system CS1 in accordance with the policy information because a computer is not registered in the provisioning computer pool 60 (NO at step S23 and step S25). In the case where the corresponding cluster control section does not exist, a standby state is established until a computer has been registered in the pool 60 through a sleep state of a predetermined time interval (NO at step S25 and step S26).

On the other hand, for example, in the case where a computer in the cluster system CS1 can be forcibly returned, the provisioning computer assigning section 41 requests a computer on the cluster system CS1 to be forcibly returned to the provisioning pool 60 (YES at step S25). The provisioning computer disconnecting section 32 of the cluster system CS1 which is requested to forcibly return a computer determines the computer (for example, C3) which can be disconnected, and registers the determined computer C3 in the provisioning computer pool 60 as a provisioning computer (step S27).

When the computer C3 disconnected from the cluster system CS1 is registered in the provisioning computer pool 60, the provisioning computer assigning section 41 of the cluster system CS2 makes a request for the provisioning computer pool 60. Then, this assigning section 41 fetches and assigns the registered computer C3 (YES at step S23 and step S24).

The provisioning computer assigning section 41, as shown in FIG. 5 fetches from the storage device 57 a boot image (OS-2-4) which is not used from among the boot images belonging to the cluster system CS2. This boot image (OS-2-4) is started up when it is connected to the computer C3.

(Provisioning Computer Disconnection Processing)

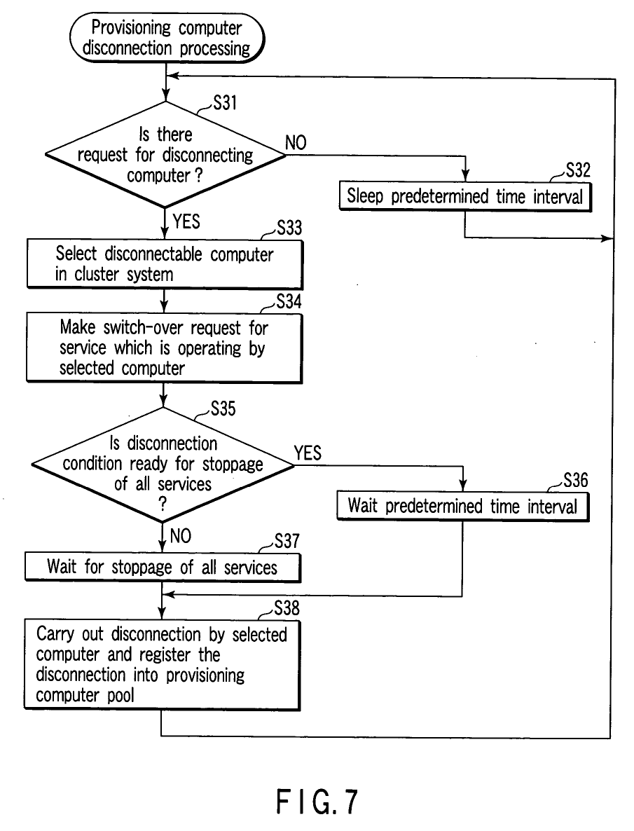

Now, procedures for provisioning computer disconnection processing according to the present embodiment will be described with reference to the flow chart of FIG. 7.

Having received a computer disconnection request, the provisioning computer disconnecting section 32 of the cluster system CS1 determines the computer C3 which can be disconnected from the cluster system CS1 in accordance with policy information (YES at step S31 and S33).

Further, the provisioning computer disconnecting section 32 makes a switch-over request for a service which is running on the determined computer C3 (step S34). In the cluster control section 30, in the case where stoppage of all services is ready under a disconnection condition in accordance with policy information, the provisioning computer disconnecting section 32 waits for stoppage of all the services; disconnects the computer C3; and registers the disconnected computer C3 as a provisioning computer in the provisioning computer pool 60 (YES at step S35, and steps S37 and S38).

On the other hand, in the case where stoppage of all services is not necessary under a disconnection condition, the provisioning computer disconnecting section 32 waits for a predetermined time interval for disconnection to be ready; disconnects the computer C3; and registers the disconnected computer C3 as a provisioning computer in the provisioning computer pool 60 (NO at step S35, and steps S36 and S38).

As has been described above, according to the present embodiment, in the case where a request for adding a provisioning computer has been made from a plurality of cluster systems, processing for disconnecting and assigning the computer can be executed from, for example, the cluster system CS1 in which a forcible return has been set, to the cluster system CS2 with its relatively high computer assignment level, in accordance with policy information. In short, a function for assigning or disconnecting a provisioning computer capable of setting a provisioning policy is provided on a cluster system by cluster system basis, thereby making it possible to assign (move) an optimal computer based on the computer assignment level between the cluster systems.

Such a cluster system and, for example, an accounting system are linked with each other, thereby making it possible to construct a system which achieves a high level SLA (Service Level Agreement) in a network service.

A variety of modes according to the present embodiment are summarized as follows.

(1) A computer system in which two or more computers are connected to each other to achieve two or more cluster systems, the computer system comprising:
at least one provisioning computer which can be used in common by the each cluster system;
a policy managing section for changeably storing policy information for specifying a policy of processing of assigning or disconnecting a provisioning computer; and
an assigning/disconnecting section for executing assignment processing for assigning a computer requested to be added from the at least one provisional computer or disconnection processing for disconnecting a redundant computer in accordance with the policy information.

(2) A computer system according to item (1), wherein the assigning/disconnecting section assigns a computer registered in the at least one provisioning computer or a computer used in another cluster system in a requested cluster system in accordance with the policy information.

(3) A computer system according to item (1), wherein the assigning/disconnecting section disconnects a computer which is used in a cluster system in accordance with the policy information, and registers the disconnected computer in the at least one provisioning computer.

(4) A computer system according to item (1), wherein the policy managing section manages a database for changeably storing the policy information, and fetches or sets the policy information from/to the database in response to an access from the each computer.

(5) A program to be executed by a computer system in which two or more computers are connected to each other, the program being included in each of the two or more cluster systems, the program causing the computer system to execute:
a procedure for executing processing of assigning a computer requested to be added from at least one provisioning computer which can be used in common by the each cluster system in accordance with changeable policy information; and
a procedure for executing processing of disconnecting the at least one provisioning computer used by the each cluster system in accordance with the policy information.

The present invention is not limited to the above-described embodiments, and can be carried out by modifying constituent elements without deviating from the spirit of the invention at the stage of implementation. In addition, a variety of modified inventions can be formed by using a proper combination of a plurality of constituent elements disclosed in the above-described embodiments. For example, some constituent elements may be erased from all of the constituent elements over the variously different embodiments. Further, the constituent elements over the variously different embodiments may be properly combined with each other.

1. A computer system including two or more computers, the computer system comprising:
a policy managing section which stores policy information for determining processing of allocating a plurality of services executed by each of the computers;
an optimal service allocation section which executes processing of allocating each service to an optimal computer; and
a service relocation section which executes processing of relocating a service allocated by the optimal service allocation section by referring to the policy information in accordance with a state of executing a service between the computers.

2. A computer system according to claim 1, wherein the service includes a high availability type service and a parallel execution type service.

3. A computer system according to claim 1, wherein, during startup of a desired service, the optimal service allocating section determines a computer which is optimal for execution of the service, by referring to the policy information stored in the policy managing section.

4. A computer system according to claim 3, wherein the policy information referred to by the optimal allocation section includes at least one of service priority; computer priority assigned to execute a service; relationships including an exclusive relationship and a dependent relationship between services; assignment of a mandatory resource for executing a service; and a load state of a computer.

5. A computer system according to claim 1, wherein the service relocating section includes sensing unit configured to, when an imbalance occurs with service allocation being executed between the computers, sense necessity of relocating a service, and relocation of the service is carried out by an output of the sensing unit.

6. A computer system according to claim 5, wherein the sensing unit senses a state of a load on each computer.

7. A computer system according to claim 6, wherein the sensing unit includes a node load monitor of each computer.

8. A computer system according to claim 1, wherein the policy information referred to by the relocating section includes at least one of enabling or disabling switch-over of a service being executed; enabling or disabling stoppage of another service being executed when no computer is capable of executing a service; a criterion for determining switch-over or stoppage of a service; and a criterion for, when a service is relocated as a load state changes, enabling or disabling stoppage of the service.

9. A computer system according to claim 8, wherein the criterion for enabling or disabling stoppage of the service includes: relocation for, when maintaining a current state is emphasized, disabling switch-over or stoppage of a service; and relocation for, when optimal allocation is emphasized, accepting switch-over or stoppage of a service.

10. A computer system according to claim 1, wherein the relocated service is stopped from being executed until a computer for executing the optimal service relocating section has been assigned, and the relocated service is executed to be automatically switched-over from a computer before relocated to a currently assigned computer.

11. A computer system according to claim 1, wherein the policy managing section stores relocation policy information for processing of relocating a service, and
the service relocating section executes processing of relocating the service in accordance with the relocation policy information.

12. A computer system according to claim 1, further comprising a load managing section which determines a load state of the each computer, and notifies a determination result which indicates load information indicating the load state and a necessity of relocation, of the service relocating section.

13. A computer system according to claim 1, wherein the service relocating section determines a necessity of relocation of a service according to a change of a load state of the each computer, and
when there is a need for relocation of the service, the service relocation section executes relocation processing including use of a reserved computer in accordance with the relocation policy information.

14. A service executing method using a computer system in which two or more computers are connected to each other to achieve one cluster system, the method comprising:
assigning a service to an optimal computer in accordance with changeable policy information; and
executing processing of relocating a service assigned by referring to the policy information for service relocation according to a state of executing a service between the computers.

15. A service executing method according to claim 14, wherein the policy information for service relocation includes at least one of enabling or disabling switch-over of a service being executed; enabling or disabling stoppage of another service being executed when no computer is capable of executing a service; a criterion for determining switch-over or stoppage of a service; and a criterion for, when a service is relocated as a load state changes, enabling or disabling stoppage of the service.

16. A service executing method according to claim 14, wherein, until a computer for executing the service allocated by the optimal service relocation section has been assigned to the relocated service, execution of the computer is stopped, and the relocated service is executed to be automatically switched-over from a computer before relocated to a currently assigned computer.

17. A program to be executed by a computer system in which two or more computers are connected to each other, for achieving one cluster system, comprising:
a procedure for executing processing of assigning a service to an optimal computer in accordance with changeable policy information; and
a procedure for executing processing of relocating the assigned service according to a change of a load state of the each computer.

18. A computer system in which two or more computers are connected to each other to achieve two or more cluster systems, the computer system comprising:
a group of provisioning computers which can be used in common by the each cluster system;
a policy managing section configured to changeably store policy information for specifying a policy of processing of assigning or disconnecting a provisioning computer; and
an assigning/disconnecting section configured to execute assignment processing of assigning a computer requested to be added from the group of provisional computers or disconnection processing of disconnecting a redundant computer in accordance with the policy information.
